(19) United States
(12) Patent Application Publication
(10) Pub. No.: US 2024/0013053 A1
(43) Pub. Date: Jan. 11, 2024

(54) METHOD AND SYSTEM FOR OPTIMIZING NEURAL NETWORKS (NN) FOR ON-DEVICE DEPLOYMENT IN AN ELECTRONIC DEVICE

(71) Applicant: SAMSUNG ELECTRONICS CO., LTD., SUWON-SI (KR)

(72) Inventors: Ashutosh Pavagada VISWESWARA, Bengaluru (IN); Payal Anand, Bengaluru (IN); Arun Abraham, Bengaluru (IN); Vikram Nelvoy Rajendiran, Bengaluru (IN); Rajath Elias Soans, Bengaluru (IN)

(73) Assignee: SAMSUNG ELECTRONICS CO., LTD., Suwon-si (KR)

(21) Appl. No.: 18/223,888

(22) Filed: Jul. 19, 2023

Related U.S. Application Data
(63) Continuation of application No. PCT/KR23/08448, filed on Jun. 19, 2023.

(30) Foreign Application Priority Data
Jul. 11, 2022 (IN) 202241039819

(51) Int. Cl. G06N 3/082; G06N 3/045

(52) U.S. Cl. CPC G06N 3/082; G06N 3/045

(57) ABSTRACT

Provided are systems and methods for optimizing neural networks for on-device deployment in an electronic device. A method for optimizing neural networks for on-device deployment in an electronic device includes receiving a plurality of neural network (NN) models, fusing at least two NN models from the plurality of NN models based on at least one layer of each of the at least two NN models, to generate a fused NN model, identifying at least one redundant layer from the fused NN model, and removing the at least one redundant layer to generate an optimized NN model.

### CROSS-REFERENCE TO RELATED APPLICATION(S)

This application is a bypass continuation of PCT International Application No. PCT/KR2023/008448, which was filed on Jun. 19, 2023, and claims priority to Indian Patent Application No. 202241039819, filed on Jul. 11, 2022, in the Indian Patent Office, the disclosures of which are incorporated herein by reference in their entireties.

### BACKGROUND

### 1. Field

The disclosure relates to systems and methods for optimizing a neural network (NN) for on-device deployment in an electronic device.

### 2. Description of Related Art

Neural networks (NNs) have been applied in a number of fields, such as face recognition, machine translation, recommendation systems and the like. In the related art if a single NN model is used to recognize an input image, then a text identifying the image is output. For example, as shown in FIG. 1, the image 120 is pre-processed before being input to the NN model 110, and the output of the NN model 110 is post-processed to obtain the text 130 identifying the image 120. The pre-processing and post-processing are performed by a central processing unit (CPU), and the operations of the NN model are performed by neural hardware, such as a neural processing unit (NPU). However, switching between the CPU and the neural hardware results in a process overhead. FIG. 2 illustrates an example in the related art of using multiple NN models to recognize an image. As shown in FIG. 2, an image 220 is processed by multiple NN models in a pipeline such as a first model 210, a second model 212, and a third model 214. However, when using the multiple NN models, the process overhead increases in proportion to the number of NN models. For example, the process overhead of the system in FIG. 2 is three times the process overhead over the system in FIG. 1.

FIG. 3 illustrates processing stages of an image signal processor (ISP) in the related art. As shown in FIG. 3, the ISP comprises 12 stages, and each stage comprises a separate NN model. Hence, the ISP in FIG. 3 comprises 12 NN models, and accordingly, the process overhead is 12 times greater as compared to single NN model processing.

Further, in case of multiple NN models, there is repeated loading/unloading of NN model files from device storage (e.g., storage of a user equipment) to/from random access memory (RAM). As shown in FIG. 4, every time the NN model interacts with CPU and/or NPU, there is loading/unloading of files from device storage to/from RAM. Hence, there is multiple loading/unloading of files, which results in increase in use of resources and delay in image processing. In particular, there is different context switching and wake up time for different backend units, which results in repeated backend memory allocation, such as M1+M2+ . . . +Mn, for ‘n’ NN models. Also, there is repeated memory allocation/deallocation for intermediate input/output buffers.

In the related art, as shown in FIG. 5, in case of multiple NN models, all the models have to be preloaded, which results in very high memory utilization for NN models and very high backend memory utilization, i.e., M1+M2+ . . . +Mn for ‘n’ NN models.

Hence, there is a need to reduce end to end inference time of applications executing a pipeline of NN Models and efficiently utilize RAM & backend compute units.

Another approach in the related art is to train a single NN model to perform tasks of multiple NN models. However, each NN model solves different sub-problems and is trained by different model developers in different frameworks. Hence, each sub problem needs individual analysis and enhancement. Also, it is difficult to collect data, train & maintain. It is also difficult to tune specific aspects of the output easily.

Hence, there is a need to retain the modularity of the NN models and still enhance the performance of the pipeline.

### SUMMARY

According to an aspect of the disclosure, a method for optimizing neural networks for on-device deployment in an electronic device, includes: receiving a plurality of neural network (NN) models; fusing at least two NN models from the plurality of NN models based on at least one layer of each of the at least two NN models, to generate a fused NN model; identifying at least one redundant layer from the fused NN model; and removing the at least one redundant layer to generate an optimized NN model.

The fusing the at least two NN models may include: determining that the at least one layer of each of the at least two NN models is directly connectable; and connecting the at least one layer of each of the at least two NN models in a predefined order of execution.

The fusing the at least two of the plurality of NN models may include: determining that the at least one layer of each of the at least two of the plurality of NN models is not directly connectable; converting the at least one layer into a converted at least one layer that is a connectable format; and connecting the converted at least one layer of each of the at least two NN models according to a predefined order of execution.

The converting the at least one layer into a converted at least one layer that is a connectable format may include: adding at least one additional layer in between the at least one layer of each of the at least two NN models, the at least one additional layer including at least one of a pre-defined NN operation layer and a user-defined operation layer.

The determining that the at least one layer of each of the at least two NN models is directly connectable may include: determining that an output generated from a preceding NN layer is compatible with an input of a succeeding NN layer.

The converting at least one layer into a converted at least one layer that is a connectable format may include: transforming an output generated from a preceding NN layer to an input compatible with a succeeding NN layer.

The identifying the at least one redundant layer from the fused NN model may include: identifying at least one layer in each of the at least two NN models being executed in a manner that an output of the at least one layer in each of the at least two NN models is redundant with respect to each other.

Each of the at least two NN models may be developed in different frameworks.

The at least one layer of each of the at least two NN models may include at least one of a pre-defined NN operation layer and a user-defined operation layer.

The method may further include: validating the fused NN model based on whether a network datatype and layout of the fused NN model is supported by an inference library, and whether a computational value of the fused NN model is above a predefined threshold value.

The method may further include: compressing the optimized NN model to generate a compressed NN model; encrypting the compressed NN model to generate an encrypted NN model; and storing the encrypted NN model in a memory.

The plurality of NN models may be configured to execute sequentially.

The method may further include: implementing the optimized NN model at runtime of an application in the electronic device.

According to an aspect of the disclosure, a system for optimizing neural networks for on-device deployment in an electronic device, the system includes: a memory storing at least one instruction; and at least one processor coupled to the memory and configured to execute the at least one instruction to: receive a plurality of neural network (NN) models; fuse at least two NN models from the plurality of NN models based on at least one layer of each of the at least two NN models, to generate a fused NN model; identify at least one redundant layer from the fused NN model; and remove the at least one redundant layer to generate an optimized NN model.

The at least one processor may be further configured to execute the at least one instruction to: determine that the at least one layer of each of the at least two NN models may be directly connectable; and connect the at least one layer of each of the at least two NN models in a predefined order of execution.

The at least one processor may be further configured to execute the at least one instruction to: determine that the at least one layer of each of the at least two of the plurality of NN models may be not directly connectable; convert the at least one layer into a converted at least one layer that may be a connectable format; and connect the converted at least one layer of each of the at least two NN models according to a predefined order of execution.

The at least one processor may be further configured to execute the at least one instruction to: add at least one additional layer in between the at least one layer of each of the at least two NN models, the at least one additional layer comprising at least one of a pre-defined NN operation layer and a user-defined operation layer.

The at least one processor may be further configured to execute the at least one instruction to: transform an output generated from a preceding NN layer to an input compatible with a succeeding NN layer.

The at least one processor may be further configured to execute the at least one instruction to: validate the fused NN model based on whether a network datatype and layout of the fused NN model is supported by an inference library, and whether a computational value of the fused NN model is above a predefined threshold value.

According to an aspect of the disclosure, a non-transitory computer readable medium may store computer readable program code or instructions which are executable by a processor to perform a method for optimizing neural networks for on-device deployment in an electronic device, the method including: receiving a plurality of neural network (NN) models; fusing at least two NN models from the plurality of NN models based on at least one layer of each of the at least two NN models; identifying at least one redundant layer from the fused NN model; and removing the at least one redundant layer to generate an optimized NN model.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a diagram depicting image recognition using a single neural network (NN) model, according to the related art;

FIG. 2 illustrates a diagram depicting image recognition using multiple NN models, according to the related art;

FIG. 3 illustrates a diagram depicting processing stages of NexGen ISP, according to the related art;

FIG. 4 illustrates a diagram depicting execution of multiple NN models, according to the related art;

FIG. 5 illustrates a diagram depicting execution of multiple NN models, according to the related art;

FIG. 6 illustrates a flow diagram depicting a method for optimizing neural networks (NN) for on-device deployment in an electronic device, according to an embodiment;

FIG. 7 illustrates a block diagram of a system for optimizing neural networks (NN) for on-device deployment in an electronic device, according to an embodiment;

FIGS. 8A, 8B, and 8C illustrate stages of optimizing neural networks (NN) for on-device deployment in an electronic device, according to an embodiment;

FIGS. 9A and 9B illustrate layer pruning of NN models, according to an embodiment;

FIGS. 10A and 10B illustrate a comparison between processing of an image in the related art and processing an image according to an embodiment of the present disclosure; and

FIG. 11 illustrates a user interface for optimizing neural networks for on-device deployment in an electronic device, according to an embodiment.

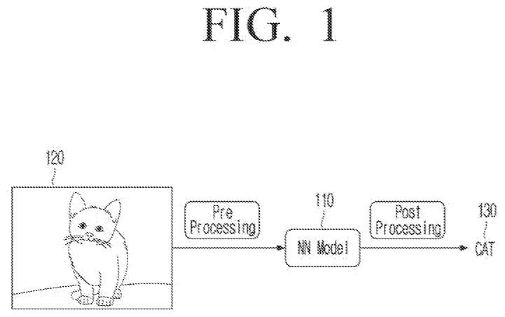

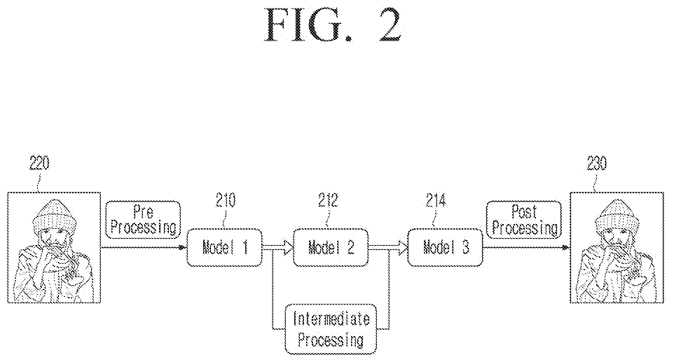

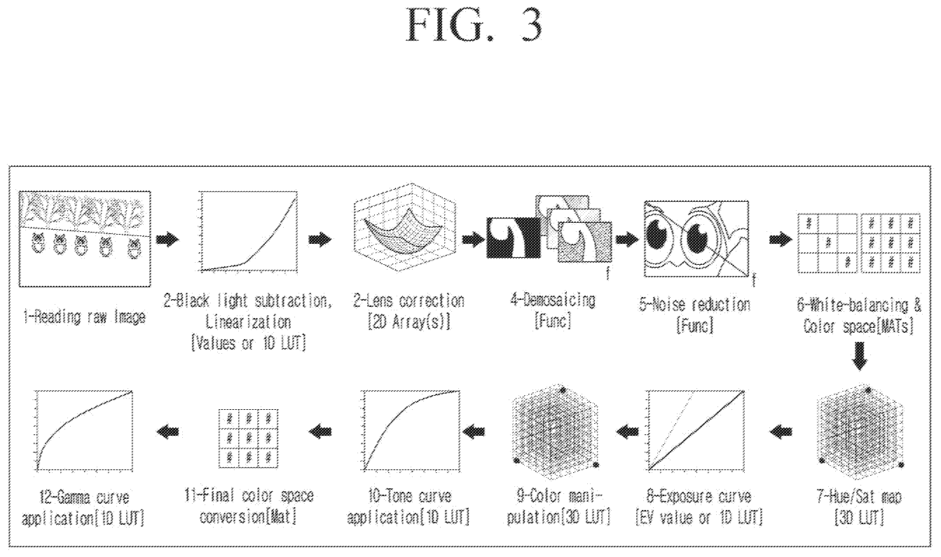

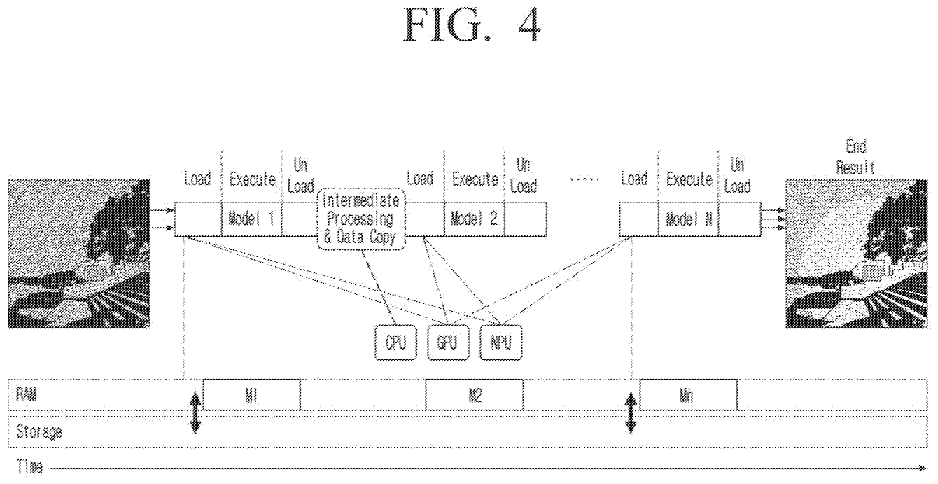

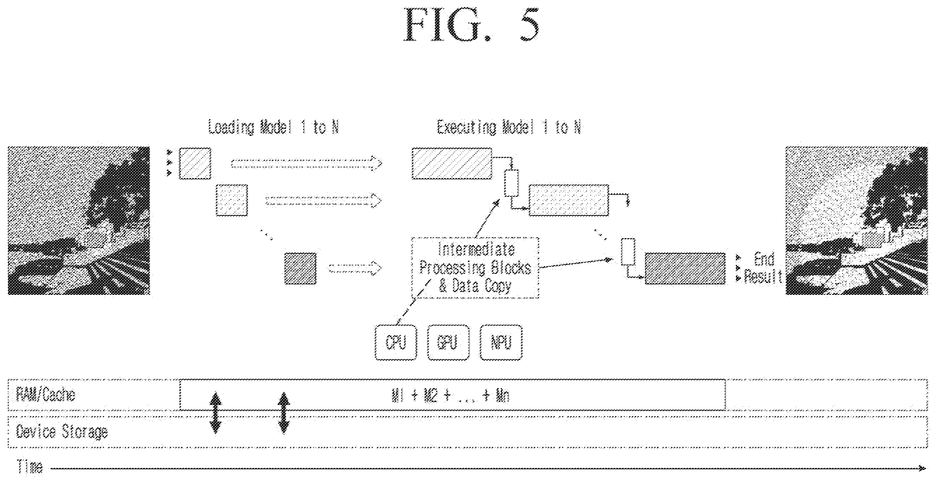

### DETAILED DESCRIPTION

For the purpose of promoting an understanding of aspects of the present disclosure, reference will now be made to various embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

It should be noted that the terms “fused model”, “fused NN model” and “connected model” may be used interchangeably throughout the specification and drawings.

Various embodiments of the present disclosure will be described below in detail with reference to the accompanying drawings in which like characters represent like parts throughout.

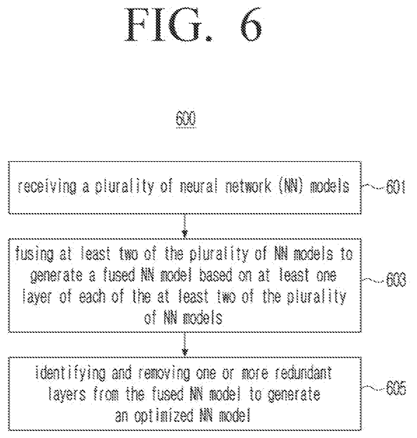

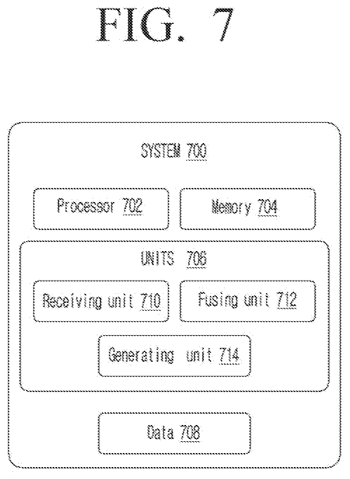

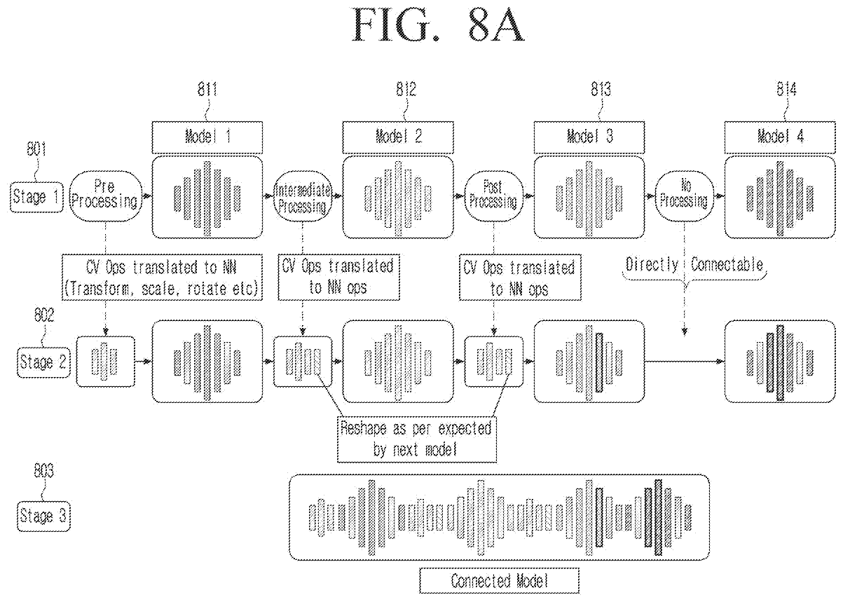

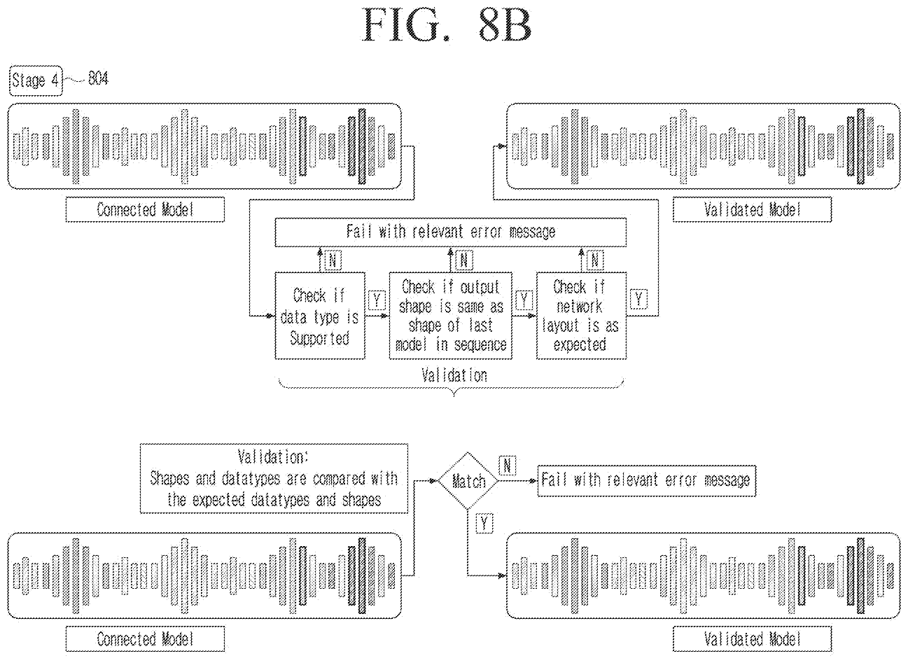

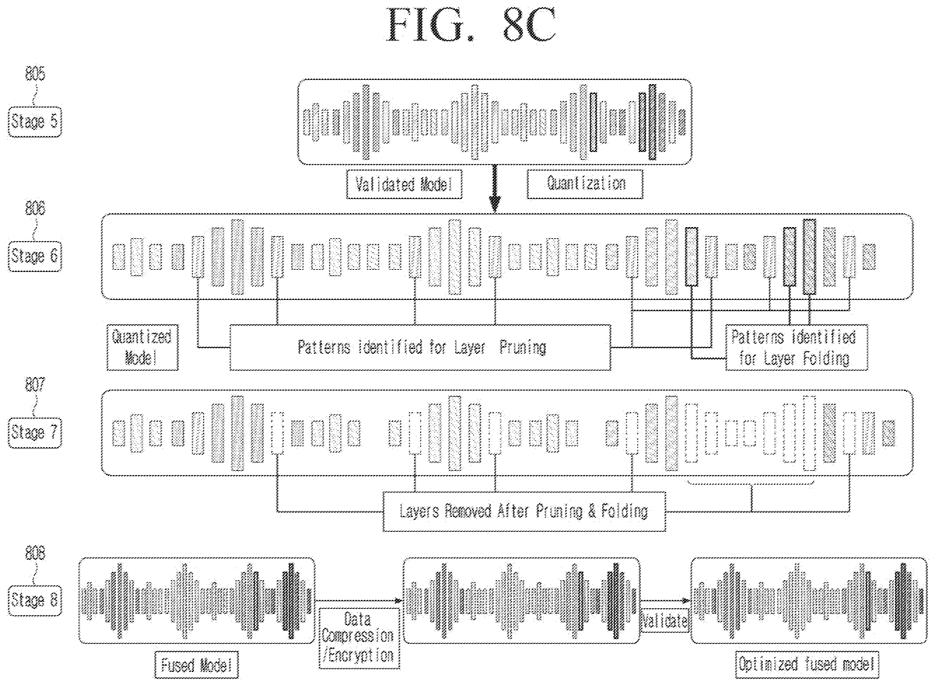

FIG. 6 illustrates a flow diagram depicting a method 600 for optimizing neural networks for on-device deployment in an electronic device, in accordance with an embodiment of the present disclosure. FIG. 7 illustrates a block diagram of a system 700 for optimizing neural networks for on-device deployment in an electronic device, in accordance with an embodiment of the present disclosure. FIGS. 8A, 8B, and 8C 8A 8C illustrate stages of optimizing neural networks for on-device deployment in an electronic device, in accordance with an embodiment of the present disclosure. For the sake of brevity, the description of the FIGS. 6, 7, 8A, 8B, and 8C 8A 8C are explained in conjunction with each other.

The system 700 may include, but is not limited to, a processor 702, memory 704, units 706, and data 708. The units 706 and the memory 704 may be coupled to the processor 702.

The processor 702 may be a single processing unit or several processing units, and each processing unit may include multiple computing units. For example, the processor 702 may be implemented as one or more microprocessors, microcomputers, microcontrollers, digital signal processors, central processing units, state machines, logic circuitries, and/or any devices that manipulate signals based on operational instructions. Among other capabilities, the processor 702 may be configured to fetch and execute computer-readable instructions and data stored in the memory 704.

The memory 704 may include any non-transitory computer-readable medium. For example, the memory 704 may include volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The units 706 may include routines, programs, objects, components, data structures, etc., which perform particular tasks or implement data types. The units 706 may also be implemented as signal processor(s), state machine(s), logic circuitries, and/or any other device or component that manipulate signals based on operational instructions.

Further, the units 706 can be implemented in hardware, instructions executed by a processing unit, or by a combination thereof. The processing unit can comprise a computer, a processor, such as the processor 702, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the units 706 may be machine-readable instructions (software) which, when executed by a processor/processing unit, perform any of the described functionalities.

In an embodiment, the units 706 may include a receiving unit 710, a fusing unit 712, and a generating unit 714.

The various units 710-714 may be in communication with each other. In an embodiment, the various units 710-714 may be a part of the processor 702. In another embodiment, the processor 702 may be configured to perform the functions of units 710-714. The data 708 serves, amongst other things, as a repository for storing data processed, received, and generated by one or more of the units 706.

It should be noted that the system 700 may be a part of an electronic device. In another embodiment, the system 700 may be connected to an electronic device. It should be noted that the term “electronic device” refers to any electronic devices used by a user such as a mobile device, a desktop, a laptop, personal digital assistant (PDA) or similar devices.

Referring to FIG. 6, at operation 601, the method 600 may comprise receiving a plurality of neural network (NN) models. For example, the receiving unit 710 may receive ‘n’ number of NN models. According to an embodiment, operation 601 may refer to the first stage 801 in FIG. 8A. As shown in FIG. 8A, the receiving unit 710 may receive a first NN model 811, a second NN model 812, a third NN model 813, and a fourth NN model 814. In an embodiment, the plurality of NN models received by the receiving unit 710 (e.g., first NN model 811, second NN model 812, third NN model 813, and fourth NN model 814) may each comprise of plurality of layers. For example, as shown in FIG. 8A, the plurality of NN models each comprise seven layers. In an embodiment, at least two NN models from the plurality of NN models may be developed in different frameworks. In an another embodiment, the plurality of NN models may be developed in a same framework.

According to an embodiment, the plurality of layers, in at least two NN models from the plurality of NN models, may comprise at least one of a pre-defined NN operation layer and a user-defined operation layer. For example, a user may define an operation of at least one layer in each of the plurality of NN models. In another example, at least one layer in each of the plurality of NN models may be a pre-defined NN operation layer. The pre-defined NN operation layer may correspond to a reshaping operation, an addition operation, a subtraction operation, etc. These NN operations (e.g., reshaping, addition, subtraction, etc.) are readily available for usage.

At operation 603, the method 600 may comprise fusing at least two NN models from the plurality of NN models based on at least one layer of each NN model that is fused, to generate a fused NN model. For example, the fusing unit 712 may fuse at least one layer of each of the at least two NN models to generate the fused NN model. In an embodiment, operation 603 may refer to the second stage 802 in FIG. 8A. In an embodiment, the fused NN model may be generated by connecting at least one layer of each of the at least two NN models in a predefined order of execution. Referring to FIG. 8A, at least one layer of the first NN model 811 and at least one layer of the second NN model 812 may be connected in a predefined order of execution to generate the fused model. In an embodiment, the predefined order of execution may refer to an order in which the layers are to be executed in each individual model. For example, at least one layer of the first NN model 811 (at least one first NN layer) may be connected with at least one layer of the second NN model 812 (at least one second NN layer) according to the order of execution of the at least one first NN layer in the first NN model 811 and the order of execution of the at least one second NN layer in the second NN model 812.

In an embodiment, the at least one layers of the models may, or may not, be directly connectable. Hence, before connecting the at least one layer of each of the NN models, it is determined whether the at least one layer of each of the NN models is directly connectable. In an embodiment, if an output generated from a preceding NN layer is compatible with an input of a succeeding NN layer, then, it may be determined that the at least one layer of each of NN models is directly connectable. Referring to FIG. 8A, for example, it may be determined that the layers of the third NN model 813 and the fourth NN model 814 are directly connectable based on determining that an output of the layers of the third NN model 813 is compatible with an input to the layers of the fourth NN model 814.

Based on a determination that at least one layer of each of the NN models is directly connectable, these layers are directly connected in the predefined order of execution to generate the fused model. For example, in reference to FIG. 8A, the layers of the third NN model 813 and the fourth NN model 814 are directly connected as the layers of these models are directly connectable.

Based on a determination that at least one layer of each of the NN models is not directly connectable, at least one layer of at least one NN model is converted into a connectable format. For example, as shown in the first stage 801 and the second stage 802 of FIG. 8A, preprocessing, intermediate processing and post processing may be performed to convert the layers of the first NN model 811, second NN model 812, and third NN model 813 into a format compatible with each other, so that the layers of these models can be connected with each other. In an embodiment, converting the layers may include transformation, scaling, rotation etc. of the layers. In an embodiment, the at least one layer may be converted by transforming an output generated from a preceding NN layer to an input compatible with a succeeding NN layer. In another embodiment, one or more additional layers may be added in between the at least one layer of each of the at least two NN models. For example, the additional layers may be a reshaping layer, addition layer, subtraction layer, multiplication layer etc. In an embodiment, the additional layers may include at least one of a pre-defined NN operation layer and a user-defined operation layer. The pre-defined NN layer operation may be reshaping, addition, subtraction etc. These NN operations are readily available for usage. After converting the layer(s) in the connectable format, these layers may be connected in the predefined order of execution to generate the fused model. Referring to FIG. 8A, the third stage 803 illustrates the fused model obtained by connecting the first NN model 811, second NN model 812, third NN model 813, and fourth NN model 814, where the layers of the first NN model 811, second NN model 812, third NN model 813 are not directly connectable, and the layers of the third NN model 813 and fourth NN model 814 are directly connectable.

Referring to the fourth stage 804 and fifth stage 805 illustrated in FIG. 8B, the fused NN model may be validated. As shown in FIG. 8B, in an embodiment, if a network datatype and layout of the fused NN model is supported by an inference library and if a computational value of the fused NN model is above a predefined threshold, then the fused NN model is valid. Otherwise, the fused NN model is invalid. In an embodiment, the predefined threshold may be configured by the user. For example, the predefined threshold may be configured based on total inference time, accuracy of the fused NN model. In an embodiment, if an output of the fused model is the same as an output of last model used in generating the fused model, then the fused NN model is valid. Otherwise, the fused NN model is invalid. In an embodiment, a notification may be provided to the user about failure of validation with relevant error. In an embodiment, the validated model may be quantized. The quantization may be required for deploying the fused model entirely on neural hardware.

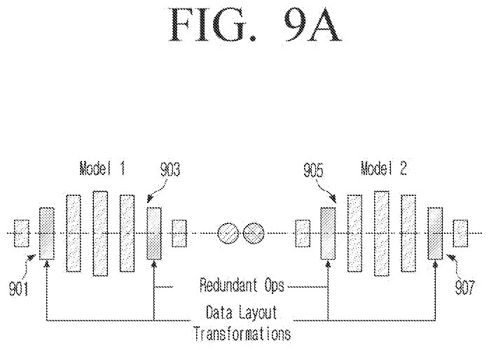

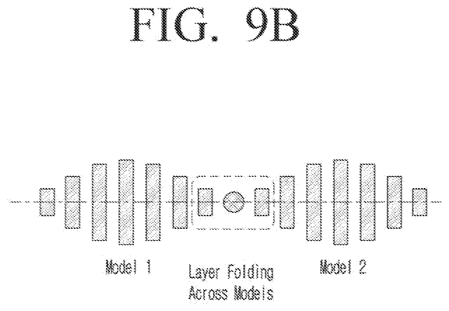

Referring to FIG. 6, at operation 605, the method 600 may comprise identifying and removing one or more redundant layers from the fused NN model to generate an optimized NN model. In an embodiment, the generating unit 714 may generate the optimized NN model. In an embodiment, the redundant layers may refer to layers which are being executed in a manner that an output of the one or more layers of the NN models is redundant with respect to each other. In other words, permute operations that would be called multiple times in case of multiple models to change the data layout, can be pruned as it will be redundant in a fused model. As shown in FIG. 9A, layers 901 and 903 of the first NN model 801, and layers 905 and 907 of the second NN model 802 are identified as being executed in a same manner, hence, these layers are redundant and may be removed. In an embodiment, as shown in FIG. 9B, layer folding (e.g., Batch normalization folding to convolution) across a plurality of NN models, such as the first NN model 801 and the second NN model 802, may be implanted in the fused model to generate the optimized NN model. In an embodiment, this operation may refer to the sixth stage 806 and the seventh stage 807 illustrated in FIG. 8C. This operation may also be referred to as “optimization” of the fused NN model. As shown in FIG. 8C, both layer folding and pruning, as described in reference to FIGS. 9A and 9B, has been used to generate the optimized fused model. In an embodiment, any known optimization method may be used to optimize the fused NN model.

After generating the optimized fused NN model, the optimized fused model may be compressed and stored in a memory (e.g., memory 704) for use, as shown in the eighth stage 808 of FIG. 8C.

In an embodiment, the plurality of NN models may be capable of executing sequentially.

After generating the optimized fused NN model, the optimized fused NN model may be implemented at runtime of an application in the electronic device.

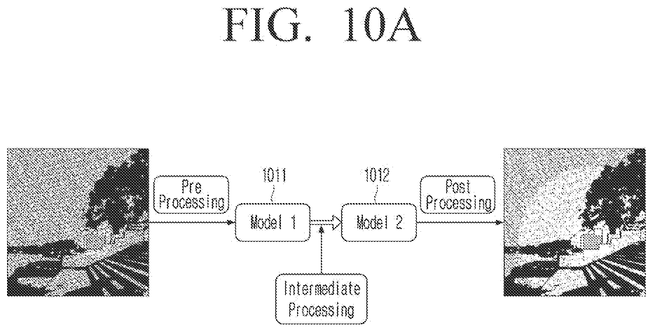

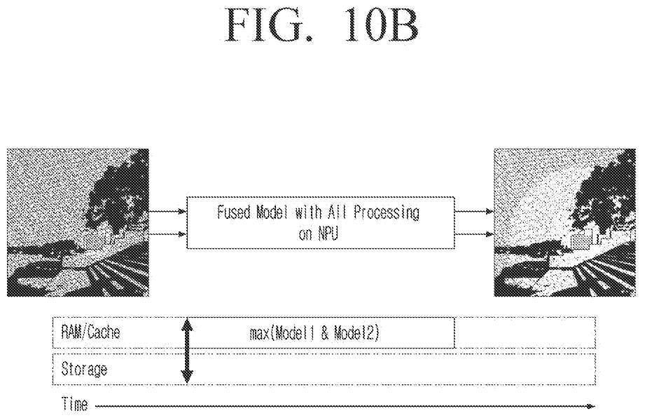

FIGS. 10A and 10B 10A 10B illustrate a comparison between processing of an image in the related art and processing of the image according to an embodiment of the present disclosure. As shown in FIG. 10A, in the related art, a camera night mode comprises two NN models (1011 and 1012) that are executed in sequence to obtain the final result image. There is some processing involved around the execution of the NN model 1011 and the NN model 1012 which is executed on CPU. As shown in FIG. 10B, pre-processing, post-processing, and intermediate processing may be represented in the form of either a predefined NN layer operation or a user defined layer operation. Hence, the present disclosure enables connecting the NN model 1011 and the NN model 1012 and optimizing the connected model (fused model) for on device deployment. As shown in FIGS. 10A and 10B, a same output image may be obtained with reduced inference time and efficient device memory usage. For example, the memory requirement for the fused model of FIG. 10B is a maximum of the NN models 1011 and 1022, in contrast to the memory requirement of the NN model 1011 plus the memory requirement of the NN model 1012 in FIG. 10A.

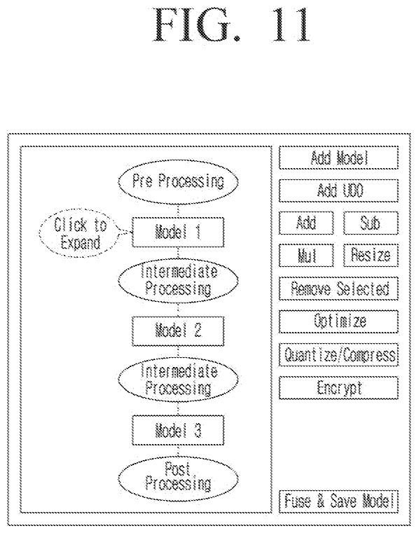

FIG. 11 illustrates a user interface for optimizing neural networks (NN) for on-device deployment in an electronic device. As shown in FIG. 11, a user may fuse a plurality of models of the user's choice and generate an optimized fused NN model. The user may generate the optimized fused NN model offline and then implement the optimized fused NN model at runtime of an application in the electronic device.

Thus, the present disclosure provides following advantages:
Improved runtime loading & Inference time
Efficient utilization of power
Efficient utilization of memory, e.g.,
Max Memory Requirement for N Separate Models=X+Y . . . +Z
Max Memory Requirement for Single Fused Model=Max (X, Y, . . . Z)
Better Memory Reuse & lesser Latency
Flexibility to mix & match NN models along with processing blocks
Ease of use & lesser maintenance efforts for model developers across teams
Maintain Modularity Offline
Lesser memory utilization for shorter period of time

While specific language has been used to describe embodiments of the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims, and their equivalents.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for optimizing neural networks for on-device deployment in an electronic device, the method comprising:
receiving a plurality of neural network (NN) models;
fusing at least two NN models from among the plurality of NN models based on at least one layer of each of the at least two NN models, to generate a fused NN model;
identifying at least one redundant layer from the fused NN model; and
removing the at least one redundant layer to generate an optimized NN model.

2. The method of claim 1, wherein the fusing the at least two NN models comprises:
determining that the at least one layer of each of the at least two NN models is directly connectable; and
connecting the at least one layer of each of the at least two NN models in a predefined order of execution.

3. The method of claim 1, wherein the fusing the at least two of the plurality of NN models comprises:
determining that the at least one layer of each of the at least two of the plurality of NN models is not directly connectable;
converting the at least one layer into a converted at least one layer that is a connectable format; and
connecting the converted at least one layer of each of the at least two NN models according to a predefined order of execution.

4. The method of claim 3, wherein the converting the at least one layer into the converted at least one layer that is a connectable format comprises:
adding at least one additional layer in between the at least one layer of each of the at least two NN models, the at least one additional layer comprising at least one of a pre-defined NN operation layer and a user-defined operation layer.

5. The method of claim 2, wherein the determining that the at least one layer of each of the at least two NN models is directly connectable comprises:
determining that an output generated from a preceding NN layer is compatible with an input of a succeeding NN layer.

6. The method of claim 3, wherein the converting at least one layer into the converted at least one layer that is a connectable format comprises:
transforming an output generated from a preceding NN layer to an input compatible with a succeeding NN layer.

7. The method of claim 1, wherein the identifying the at least one redundant layer from the fused NN model comprises:
identifying at least one layer in each of the at least two NN models being executed in a manner that an output of the at least one layer in each of the at least two NN models is redundant with respect to each other.

8. The method of claim 1, wherein each of the at least two NN models are developed in different frameworks.

9. The method of claim 1, wherein the at least one layer of each of the at least two NN models comprises at least one of a pre-defined NN operation layer and a user-defined operation layer.

10. The method of claim 1, further comprising:
validating the fused NN model based on whether a network datatype and layout of the fused NN model is supported by an inference library, and whether a computational value of the fused NN model is above a predefined threshold value.

11. The method of claim 1, further comprising:
compressing the optimized NN model to generate a compressed NN model;
encrypting the compressed NN model to generate an encrypted NN model; and
storing the encrypted NN model in a memory.

12. The method of claim 1, wherein the plurality of NN models are configured to execute sequentially.

13. The method of claim 1, further comprising:
implementing the optimized NN model at runtime of an application in the electronic device.

14. A system for optimizing neural networks for on-device deployment in an electronic device, the system comprising:
at least one memory storing at least one instruction; and
at least one processor configured to execute the at least one instruction to:
receive a plurality of neural network (NN) models;
fuse at least two NN models from among the plurality of NN models based on at least one layer of each of the at least two NN models, to generate a fused NN model;
identify at least one redundant layer from the fused NN model; and
remove the at least one redundant layer to generate an optimized NN model.

15. The system of claim 14, wherein the at least one processor is further configured to execute the at least one instruction to:
determine that the at least one layer of each of the at least two NN models is directly connectable; and
connect the at least one layer of each of the at least two NN models in a predefined order of execution.

16. The system of claim 14, wherein the at least one processor is further configured to execute the at least one instruction to:
determine that the at least one layer of each of the at least two of the plurality of NN models is not directly connectable;
convert the at least one layer into a converted at least one layer that is a connectable format; and
connect the converted at least one layer of each of the at least two NN models according to a predefined order of execution.

17. The system of claim 16, wherein the at least one processor is further configured to execute the at least one instruction to:
add at least one additional layer in between the at least one layer of each of the at least two NN models, the at least one additional layer comprising at least one of a pre-defined NN operation layer and a user-defined operation layer.

18. The system of claim 16, wherein the at least one processor is further configured to execute the at least one instruction to:
transform an output generated from a preceding NN layer to an input compatible with a succeeding NN layer.

19. The system of claim 14, wherein the at least one processor is further configured to execute the at least one instruction to:
validate the fused NN model based on whether a network datatype and layout of the fused NN model is supported by an inference library, and whether a computational value of the fused NN model is above a predefined threshold value.

20. A non-transitory computer readable medium for storing computer readable program code or instructions which are executable by a processor to perform a method for optimizing neural networks for on-device deployment in an electronic device, the method comprising:
receiving a plurality of neural network (NN) models;
fusing at least two NN models from among the plurality of NN models based on at least one layer of each of the at least two NN models, to generate a fused NN model;
identifying at least one redundant layer from the fused NN model; and
removing the at least one redundant layer to generate an optimized NN model.
